(19) United States
(12) Patent Application Publication
(10) Pub. No.: US 2008/0044142 A1
(43) Pub. Date: Feb. 21, 2008

(54) LIGHT EMITTING DIODE MODULE

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,582

(22) Filed: Nov. 30, 2006

(30) Foreign Application Priority Data
Aug. 18, 2006 (CN) 200610062212.8

(51) Int. Cl. G02B 6/36

(52) U.S. Cl. 385/92

(57) ABSTRACT

An LED module includes a base, an LED chip, a converging lens, a solid immersion lens, and a light guide plate in that order. The LED chip is for emitting light with a central wavelength and is mounted on the base. The solid immersion lens includes a flat surface facing away from the LED chip. The converging lens is arranged between the LED chip and the solid immersion lens. The light guide plate is disposed adjacent to the flat surface of the solid immersion lens. A distance between the flat surface and the light guide plate is greater than zero and less than the central wavelength.

### BACKGROUND OF THE INVENTION

1. Field of the Invention

The present invention relates to light sources, and particularly to a light emitting diode (LED) module.

2. Description of Related Art

LEDs are semiconductors that convert electrical energy into light. Compared to conventional light sources, the LEDs have higher energy conversion efficiency, higher radiance (i.e., they emit a larger quantity of light per unit area), longer lifetime, higher response speed, and better reliability. At the same time, LEDs generate less heat. Thus LED modules are widely used in particular as a semiconductor light source in conjunction with imaging optical systems, such as displays, projectors, and so on.

However, light from LEDs scatters in all directions. In this case, a small part of the light is utilized by the LED module, while a large part of the light is wasted. Thus the efficiency of LED modules is low.

It is therefore desirable to find a new LED module which can overcome the above mentioned problems.

### SUMMARY OF THE INVENTION

In a preferred embodiment, an LED module includes a base, an LED chip, a converging lens, a solid immersion lens, and a light guide plate in that order. The LED chip is for emitting light with a central wavelength (i.e., the wavelength in which the light emission energy forms a central peak) and is mounted on the base. The solid immersion lens includes a flat surface facing away from the LED chip. The converging lens is arranged between the LED chip and the solid immersion lens. The light guide plate is disposed adjacent to the flat surface of the solid immersion lens. A distance between the flat surface and the light guide plate is greater than zero and less than the central wavelength.

### BRIEF DESCRIPTION OF THE DRAWINGS

Many aspects of embodiments can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is a schematic, cross-sectional view of an LED module according to a first embodiment; and

FIG. 2 is a schematic, cross-sectional view of an LED module according to a second embodiment.

### DETAILED DESCRIPTION OF THE INVENTION

Embodiments will now be described in detail below with reference to the drawings.

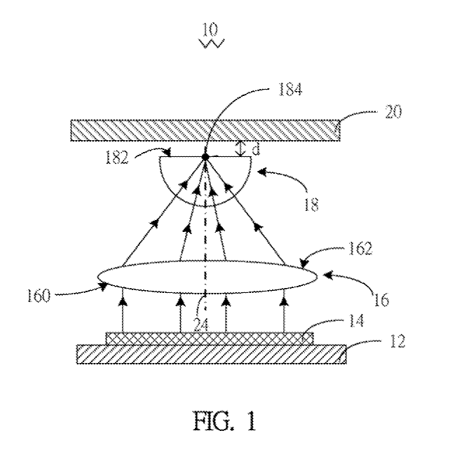

Referring to FIG. 1, an LED module 10 is shown according to a first embodiment. The LED module 10 includes a base 12, an LED chip 14, a converging lens 16, a solid immersion lens (SIL) 18, and a light guide plate (LGP) 20. The LED chip 14 is for emitting light with a central wavelength λ. The LED chip 14 is disposed on the base 12 and connected with the base 12 electrically. An optical axis 24 of the converging lens 16 aligns with that of the SIL 18. The SIL 18 includes a flat surface 182 facing away from the LED chip 14. The converging lens 16 is arranged between the LED chip 14 and the SIL 18. The LGP 20 is disposed adjacent to the flat surface of the SIL 18. A distance d between the flat surface 182 and the LGP 20 is greater than zero and less thanλ, wherein λ is the central wavelength. For example, when the LED chip 14 is a blue LED, the distance d is larger than zero and less than 405 nanometers (nm).

The base 12 can be a flexible printed circuit board (FPCB). The LED chip 14 can be cubic, hemispherical, or pyramidic. The LED chip 14 is cubic in the present embodiment. The LED chip 14 can be a red LED chip, a green LED chip, or a blue LED chip. A reflective film (not shown) can be formed on the bottom of the LED chip 14 for reflecting light from the LED chip 14.

The converging lens 16 includes a light incidence surface 160 and a light emitting surface 162. The surface 160 can be spherical or aspherical, and is asperical in the present embodiment. The surface 162 can be spherical or aspherical, and is asperic in the present embodiment. An aspherical surface mainly includes a quadric surface and a highly curved surface. Radius of curvature of the aspherical surface is changeable with positions of points on the aspherical surface. The aspherical surface can be a hyperbolic surface, an ellipsoid surface, and a parabolic surface. In the illustrated embodiment, the surfaces are both ellipse-shaped surfaces. When the converging lens 16 is aspherical, the lenses 16 can reduce optical aberration. Therefore, imaging using the aspherical converging lens 16 is better than that of a spherical converging lens.

The converging lens 16 can be made of transparent optical material, for example, polymethyl methacrylate (PMMA), polycarbonate (PC), and polyetherimide (PIE). The numerical aperture (NA) of the converging lens 16 can be in an approximate range from 0.55 to 0.8.

A refractive index of the SIL 18 is in an approximate range from 1.45 to 3, preferably in an approximate range from 2 to 2.7. An NA of the SIL 18 is in an approximate range from 1 to 2. The SIL 18 can be made of optical material with a high refractive index, for example, zinc sulphide (ZnS), and gallium phosphate (GaP). The SIL 18 can be hemispherical with a spherical center 184. An incident angle of light from the converging lens 16 may be larger than a critical angle of the SIL 18. Thus evanescent wave can be formed between the SIL 18 and the LGP 20. Most of the evanescent wave is coupled into the LGP 20 because the SIL 18 is so close to the LGP 20. In other words, most of the evanescent wave is coupled into the LGP 20 because the distance d between the flat surface 182 and the LGP 20 is less thanλ, wherein λ is the central wavelength of the light. In this way, a large part of the light is used in the LED module 10, thus enhancing brightness of the LED module 10. The LED module 10 can be used in backlight modules of liquid crystal display (LCD).

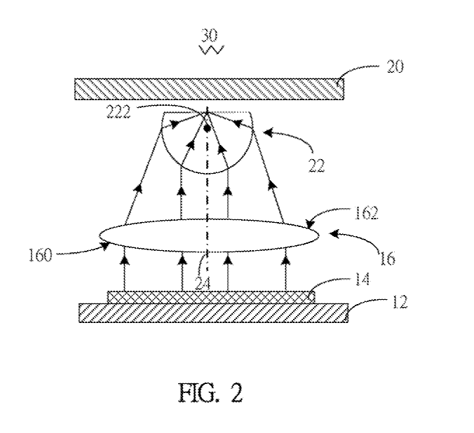

Referring to FIG. 2, an LED module 30 is shown according to a second embodiment. The LED module 30 is similar to the LED module 10, but the SIL 22 is a hyper-hemisphere aplanat with a spherical center 222.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An light emitting diode ( LED ) module comprising:
a base;
an LED chip for emitting light with a central wavelength, the LED chip mounted on the base;
a solid immersion lens comprising a flat surface facing away from the LED chip;
a converging lens arranged between the LED chip and the solid immersion lens; and
a light guide plate disposed adjacent to the flat surface of the solid immersion lens,
wherein a distance between the flat surface and the light guide plate is greater than zero and less than the central wavelength.

2. The LED module as claimed in claim 1, wherein the base is a flexible printed circuit board.

3. The LED module as claimed in claim 1, wherein the converging lens is selected from the group consisting of an aspherical lens and a hemispherical lens.

4. The LED module as claimed in claim 1, wherein a numerical aperture of the converging lens is in an approximate range from 0.55 to 0.8.

5. The LED module as claimed in claim 1, wherein a refractive index of the solid immersion lens is in an approximate range from 1.45 to 3.

6. The LED module as claimed in claim 5, wherein a refractive index of the solid immersion lens is in an approximate range from 2 to 2.7.

7. The LED module as claimed in claim 1, wherein a numerical aperture (NA) of the solid immersion lens is in an approximate range from 1 to 2.

8. The LED module as claimed in claim 1, wherein the solid immersion lens is selected from the group consisting of a hemisphere solid immersion lens and a super-hemisphere aplanat.

9. The LED module as claimed in claim 1, wherein the solid immersion lens comprises a material selected from the group consisting of zinc sulphide and gallium phosphate.
